(19) United States
(12) Patent Application Publication
(10) Pub. No.: US 2005/0138350 A1
(43) Pub. Date: Jun. 23, 2005

(54) Configurable secure FTP

(76) Inventor: Ravi S. Hariharan, Nashua, NH (US)

Correspondence Address: STEPHEN R. LOE, THE LAW OFFICE OF STEPHEN R. LOE, P.O. BOX 649, FRISCOE, TX, 75034, US

(21) Appl. No.: 10/744,403

(22) Filed: Dec. 23, 2003

(51) Int. Cl. H04L 9/00

(52) U.S. Cl. 713/151

(57) ABSTRACT

A method, system, and computer program product for providing automatic reconfigurable secure File Transfer Protocol (sFTP) software for sFTP transfers for clients is provided. In one embodiment, a property file is created, wherein the property file contains configuration information, such as, for example, destination host, port, user ID, password, pickup directory, destination directory, and encryption public key, for each client. Software component parameters used for sending and receiving files via a FTP and for encrypting the files prior to sending the files and decrypting the files after receiving the files are configured based on the configuration information in the property file. The property file is monitored for changes and the software components for a client are automatically reconfigured if the property file changes to reflect the new configuration information.

### BACKGROUND OF THE INVENTION

1. Technical Field

The present invention relates generally to computer software and, more particularly, to secure transmissions across networks.

2. Description of Related Art

The “Internet” is a worldwide network of computers. Today, the Internet is made up of more than 65 million computers in more than 100 countries covering commercial, academic and government endeavors. Originally developed for the U.S. military, the Internet became widely used for academic and commercial research. Users had access to unpublished data and journals on a huge variety of subjects. Today, the Internet has become commercialized into a worldwide information highway, providing information on every subject known to humankind.

The Internet's surge in growth in the latter half of the 1990s was twofold. As the major online services (AOL, CompuServe, etc.) connected to the Internet for e-mail exchange, the Internet began to function as a central gateway. A member of one service could finally send mail to a member of another. The Internet glued the world together for electronic mail, and today, the Internet mail protocol is the world standard.

Secondly, with the advent of graphics-based Web browsers such as Mosaic and Netscape Navigator, and soon after, Microsoft's Internet Explorer, the World Wide Web took off. The Web became easily available to users with PCs and Macs rather than only scientists and hackers at UNIX workstations. Delphi was the first proprietary online service to offer Web access, and all the rest followed. At the same time, new Internet service providers rose out of the woodwork to offer access to individuals and companies. As a result, the Web has grown exponentially providing an information exchange of unprecedented proportion. The Web has also become “the” storehouse for drivers, updates and demos that are downloaded via the browser.

In most Enterprise Application Integration (EAI) or enterprise data transfers, data needs to be secure and most of the data transfer is done using File Transfer Protocol (FTP). There are two types of secure FTP, one that establishes a secure channel and transmits and receives files using that channel. The other transmits and receives files that have been encrypted using a strong encryption algorithm over the public internet.

Providing secure FTP this way is a challenge since we either need a configurable application/server that secures the channel itself or a configurable application that automatically encrypts the file and sends it to whichever destination the configuration suggests it to.

There are few applications that provide secure FTP and these applications are neither automatic nor are they configurable to support multiple customers (destinations). Moreover there are not many systems that support a flexible secure FTP mechanism and it is expensive to customize these products. Therefore, it would be desirable to have a method, system, and computer program product an improved method for providing secure FTP that eliminates or reduces the problems associated with prior art secure FTP systems.

### SUMMARY OF THE INVENTION

The present invention provides a method, system, and computer program product for providing automatic reconfigurable secure File Transfer Protocol (sFTP) software for sFTP transfers for clients. In one embodiment, a property file is created, wherein the property file contains configuration information, such as, for example, destination host, port, user ID, password, pickup directory, destination directory, and encryption public key, for each client. Software component parameters used for sending and receiving files via a FTP and for encrypting the files prior to sending the files and decrypting the files after receiving the files are configured based on the configuration information in the property file. The property file is monitored for changes and the software components for a client are automatically reconfigured if the property file changes to reflect the new configuration information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server is depicted in accordance with the present invention;

FIG. 3 depicts a block diagram of a data processing system in which the present invention may be implemented;

FIG. 4 depicts an exemplary Universal Modeling Language (UML) for a configurable secure FTP application in accordance with one embodiment of the present invention;

FIG. 5 depicts the Observer pattern 408 section of the UML 400;

FIG. 6 depicts the factory pattern 410 section of the UML 400;

FIG. 7 depicts the doubleton pattern 428 section of UML 400;

FIG. 8 depicts the singleton pattern 430 section of UML 400;

FIG. 9 depicts the facade pattern 426 section of UML 400; and

FIG. 10 depicts a schematic diagram illustrating an exemplary configurable secure FTP application flow in accordance with one embodiment of the present invention.

### DETAILED DESCRIPTION OF THE PREFERRED EMBODIMENT

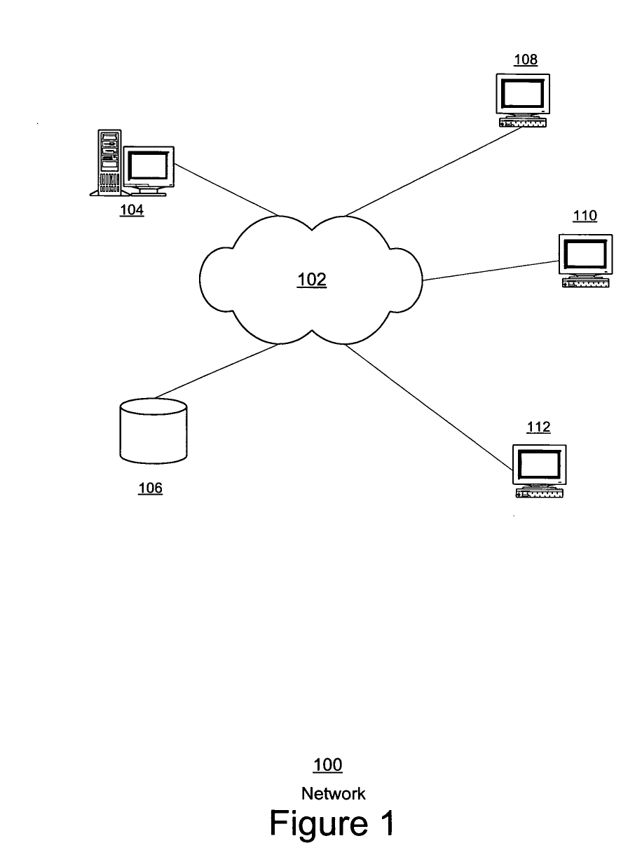

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 may provide files to or receive files from clients 108-112. Additionally, clients 108-112 may communicate with each other to exchange files. Distributed data processing system 100 may include additional servers, clients, and other devices not shown.

The present invention provides a simple yet configurable secure FTP using, for example, Pretty Good Privacy (PGP) to encrypt files with a provision to add in other security providers. It automatically sends and receives files to and from the configured hosts 104, 108-112. PGP has become the industry standard for Public Key Infrastructure (PKI) encryption as used by applications, including FTP.

The present invention addresses the problems with the prior art by providing a “text file” configuration that, when changed will cause an automatic update of the running application to incorporate the changes. Thus, from a maintenance perspective it is easy to implement.

The present invention uses, for example, an existing PGP key-ring so it does not need any special needs as far as PKI infrastructure is concerned. Since the application is implemented, in one embodiment, as a pure java solution, it can be run from any platform. The configurable secure FTP of the present invention is described in greater detail below.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

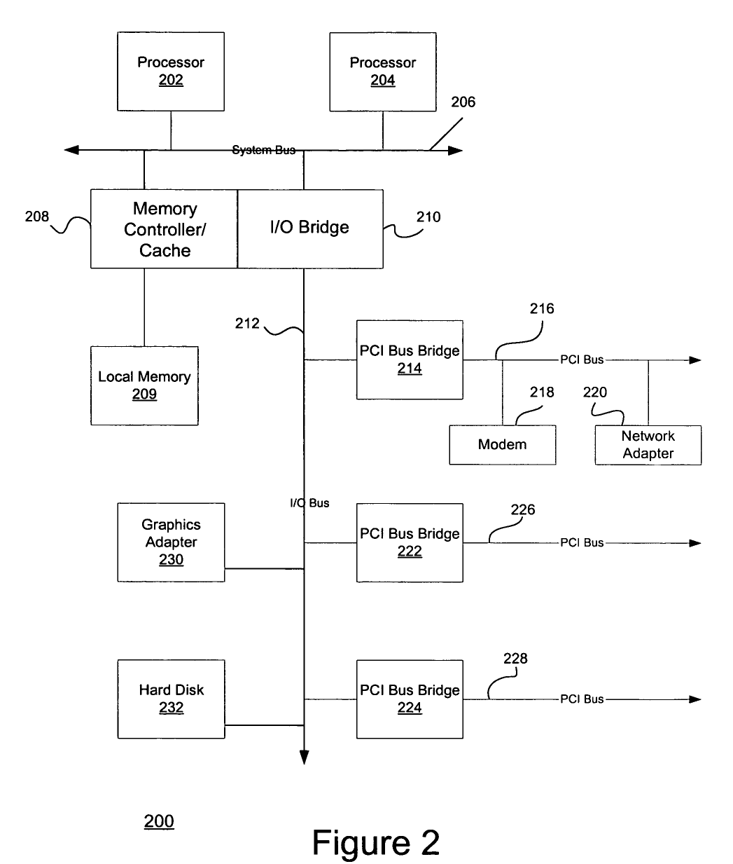

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

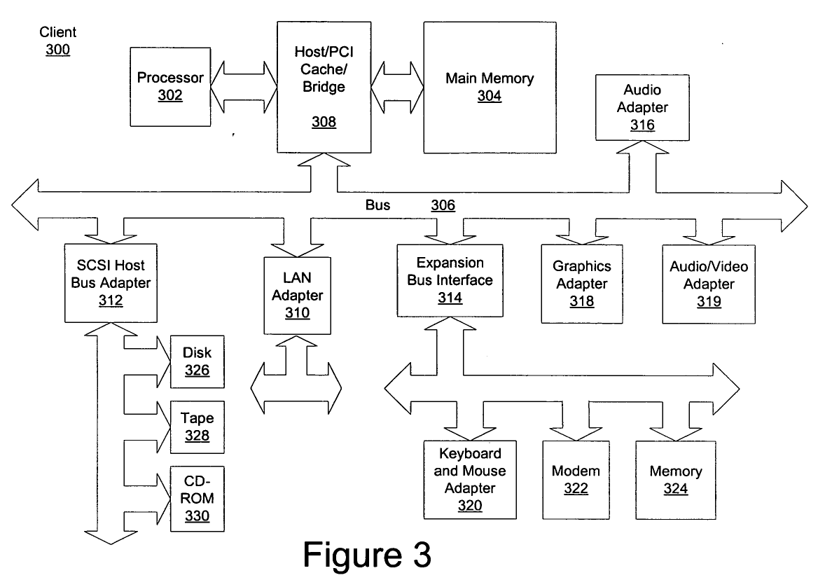

With reference now to FIG. 3, a block diagram of a data processing system in which the present invention may be implemented is illustrated. Data processing system 300 is an example of a client computer that may be implemented as any one of clients 108-112 depicted in FIG. 1. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

The configurable secure FTP of the present invention is dynamically configurable. To achieve this, a property file is used to create individual configurations for clients/customers, with details such as, for example, destination host, port, user identification (ID), password, pickup directory, and Pretty Good Privacy (PGP) or other encryption public key file. The configurable secure FTP of the present invention has a low memory footprint and low resource usage. This is achieved by having the application functioning in threads and, as a rule, files are loaded in memory for processing. Because many enterprises and users may use non-PGP encrypted files, the security provider preferences of a client/customer are configurable and, in one embodiment of the present invention, the configurable secure FTP application has a facade used by the application. The present invention also provides for content isolation. The purpose of content isolation is to segregate the files by customer and keep the files and security context information local to that client or customer. This way one customer will not be affected by another customer configuration. Additionally, if there is an invalid configuration for a particular customer, this will be of no consequence to the FTP process of other customers. The configurable secure FTP application of the present invention also provides that the “receives” can be completely isolated from the “sends” as they are two different processes.

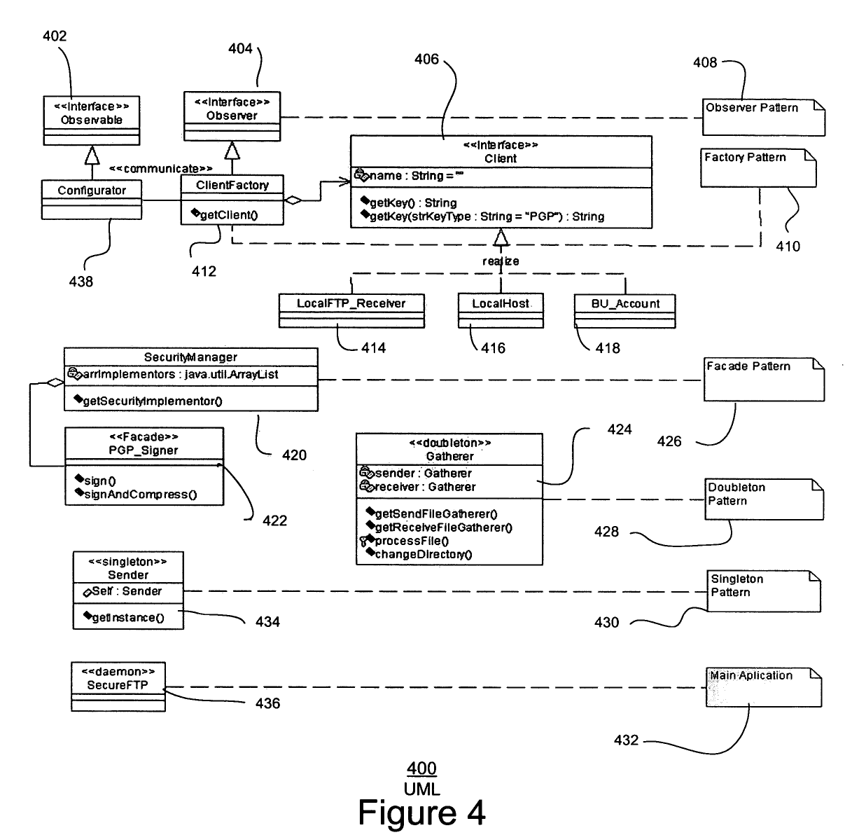

With reference now to FIG. 4, an exemplary Universal Modeling Language (UML) for a configurable secure FTP application is depicted in accordance with one embodiment of the present invention. The main application should run as a daemon and it is required that it has a small memory footprint. Therefore the application is implemented using threads and care is taken such that files are used only by reference to file paths. Files are accessed for encryption and/or compression and decryption only.

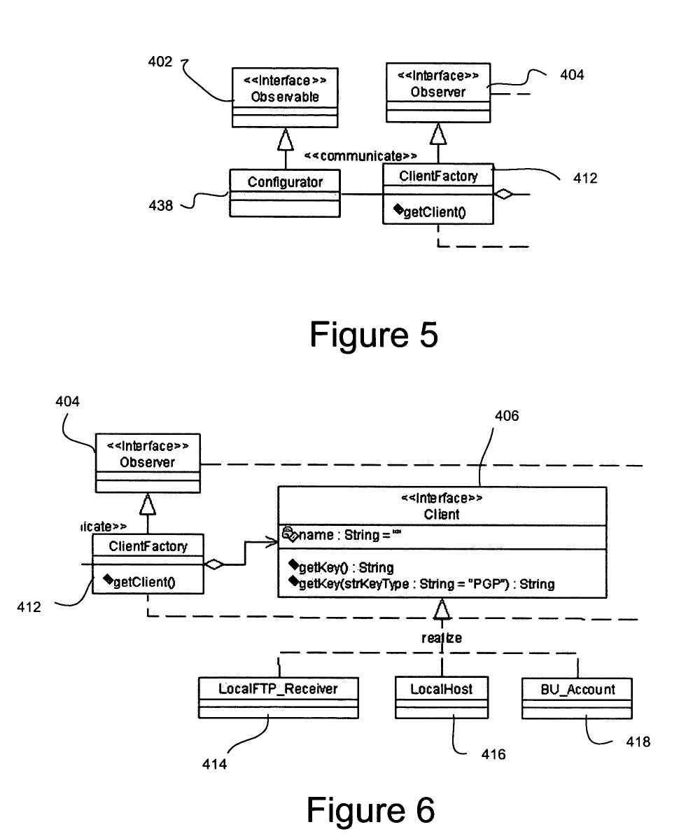

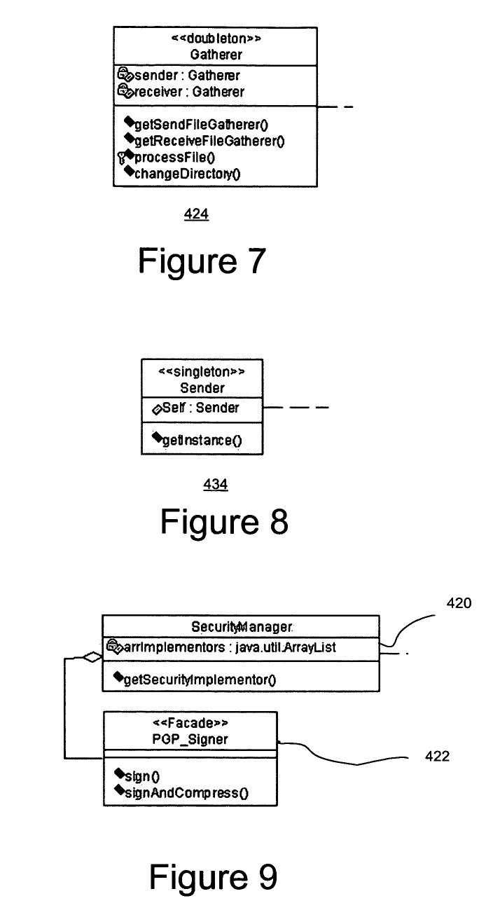

The classes used by the application are
SecureFTP—the main application class (daemon thread)
Gatherer—the file gatherers implemented as doubleton, one for send & the other for receive
SecurityManager—Aggregates the various signing algorithm facades
PGP_Signer—Facade for any security provider
ClientFactory—Factory class to create clients with respective information
Client—Interface for objects that can hold a client's information
Configurator—object that dynamically configures the Client's information
Sender—the object responsible of sending an encrypted file to the destination listed by the client's configuration information
   To explain the UML 400 better, the following sections define the patters used and the section following that will explain how all these fit together. The sections are:
The Observer depicted in FIG. 5
The Factory depicted in FIG. 6
The Singleton depicted in FIG. 7
The Doubleton depicted in FIG. 8
The Facade depicted in FIG. 9

With reference now to FIG. 5, the Observer pattern 408 section of the UML 400 is depicted. The Objects for this section are Configurator 438 and ClientFactory 412. The Configurator 438 implements the observable interface 402 such that this changes whenever the property file changes. The ClientFactory 412 will be notified to update the client objects. The Configurator 438 is running on a thread of its own and will periodically check to see if the properties file has been modified. If the file has been modified, the changes are picked up by the Configurator object 438. This change in properties is observed by the ClientFactory 412. The ClientFactory object 412, that runs in its own thread will automatically reconfigure itself and will update the properties of the Client objects.

With reference now to FIG. 6, the factory pattern 410 section of the UML 400 is depicted. The ClientFactory 412 is the factory object for creating the individual objects that hold a client's information such as the PGP public key file, PGP Key, destination directory and destination host and port. Once the ClientFactory gets notified by the Configurator 438, it builds/rebuilds its list of client objects. The classes are built by using reflection as this needs to be dynamically done and new client objects need be created. If the objects are already created then these objects are modified. The client objects exhibit a bean like behavior. The objects are serializable and hence can be persisted.

With reference now to FIG. 7, the doubleton pattern 428 section of UML 400 is depicted. The Gatherer object 424 provides the implementation to check for files from a particular location in the hard disk and “pick it up” to either decrypt or encrypt and send it to the client. The doubleton 428 achieves the implementation of the pickup mechanism exclusively for send and receive.

With reference now to FIG. 8, the singleton pattern 430 section of UML 400 is depicted. The Sender 434, as the name suggests, sends a file via FTP to a known destination. This operation is requested by the SendFileGatherer object of Gatherer 424. The sender 434 is implemented as a Singleton. Sender 434 is running on its own thread and has a (priority) queue of files and destinations. In this way it is ensured that only one send operation is done at a time.

With reference now to FIG. 9, the facade pattern 426 section of UML 400 is depicted. The PGP_Signer object 422 is a facade for the PGP implementation of various security operations such as signing, encryption, decryption and compression of the file/streams, etc. This is implemented as a facade as this can be configured as client specific information. The application PGP for the signing and encryption, provided there is a class that acts a facade to use PGP methods for the application's needs. The SecurityManager 420 has a reference to the PGP interface facade 422. Before the encryption is done, the SendFileGatherer 424 will apply the configured interface to sign or sign and compress the file before sending it to the Sender object 434 to send it to its destination.

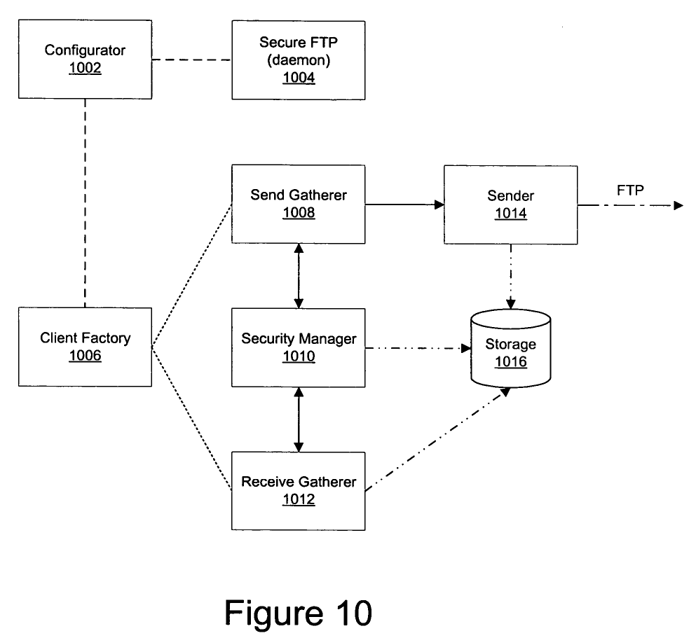

With reference now to FIG. 10, a schematic diagram illustrating an exemplary configurable secure FTP application flow is depicted in accordance with one embodiment of the present invention. The application is started by loading the SecureFTP daemon 1004. The daemon 1004, creates the configurator 1002; the configurator 1002 reads the property files and notifies the ClientFactory 1006. The client factory reads the information from the Configurator 1002 and creates a client object for each configuration. The daemon 1004 creates the Send 1008 and Receive 1012 file gatherers. Each gatherer 1008 and 1012 will cycle through the list of clients and will start to process the files in their respective directories. The send gatherer 1008 will encrypt the files and add the file path and client name to the Sender's queue to be sent via FTP by sender 1014. The receive gatherer 1012 will decrypt the files and store the decrypted files locally in the configured directories on local storage 1016. Both the send 1008 and receive 1012 file gatherers interact with the SecurityManager 1010 to get the facade object to apply the configured encryption/decryption algorithm to process the files. This cycle continues.

Those skilled in the art will recognize various modifications that can be made without departing from the scope and spirit of the present invention. For example, non-PGP methods could be used for encrypting and decrypting files. By doing this, the product is enhanced to cater to other encrypting algorithms. (in accordance with the underlying architecture.) The configurable secure FTP application may also be modified to utilize compression/decompression methods before encryption/decryption to reduce payload.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing automatic reconfigurable secure file transfer protocol transfers for a client, the method comprising:
creating a property file, wherein the property file contains configuration information for the client;
configuring software component parameters for sending and receiving files via a file transfer protocol and for encrypting the files prior to sending the files and decrypting the files after receiving the files, wherein the software component parameters are determined by the configuration information;
monitoring the property file;
reconfiguring software components for a client if the property file changes.

2. The method as recited in claim 1, wherein the property file is one of a plurality of property files wherein each property file corresponds to a different client and each of the plurality of property files is isolated from the other ones of the plurality of property files.

3. The method as recited in claim 1, wherein the configuration information comprises at least one of destination host, port, user identification, password, pickup directory, destination directory, and encryption public key file.

4. The method as recited in claim 1, further comprising:
receiving a encrypted file via file transfer protocol;
determining the identity of a client for which the file is intended;
decrypting the encrypted file to create a decrypted file using a decryption algorithm determined by the property file associated with the client for which the file is intended.

5. The method as recited in claim 4, further comprising:
prior to decrypting the encrypted file, decompressing the encrypted file.

6. The method as recited in claim 1, further comprising:
encrypting a file to be sent to a recipient using an encryption algorithm determined by the property file associated with the client for which the file is associated to produce an encrypted file;
sending the encrypted file to a recipient using file transfer protocol.

7. The method as recited in claim 6, further comprising:
prior to encrypting the file, compressing the file.

8. A computer program product in a computer readable media for use in a data processing system for providing automatically configurable secure file transfer protocol for a client, the computer program product comprising:
first instructions for creating a property file, wherein the property file contains configuration information for the client;
second instructions for configuring software component parameters for sending and receiving files via a file transfer protocol and for encrypting the files prior to sending the files and decrypting the files after receiving the files, wherein the software component parameters are determined by the configuration information;
third instructions for monitoring the property file;
fourth instructions for reconfiguring software components for a client if the property file changes.

9. The computer program product as recited in claim 8, wherein the property file is one of a plurality of property files wherein each property file corresponds to a different client and each of the plurality of property files is isolated from the other ones of the plurality of property files.

10. The computer program product as recited in claim 8, wherein the configuration information comprises at least one of destination host, port, user identification, password, pickup directory, destination directory, and encryption public key file.

11. The computer program product as recited in claim 8, further comprising:
fifth instructions for receiving a encrypted file via file transfer protocol;
sixth instructions for determining the identity of a client for which the file is intended;
seventh instructions for decrypting the encrypted file to create a decrypted file using a decryption algorithm determined by the property file associated with the client for which the file is intended.

12. The computer program product as recited in claim 11, further comprising:
eighth instructions for, prior to decrypting the encrypted file, decompressing the encrypted file.

13. The computer program product as recited in claim 8, further comprising:
fifth instructions for encrypting a file to be sent to a recipient using an encryption algorithm determined by the property file associated with the client for which the file is associated to produce an encrypted file;
sixth instructions for sending the encrypted file to a recipient using file transfer protocol.

14. The computer program product as recited in claim 13, further comprising:
seventh instructions for, prior to encrypting the file, compressing the file.

15. A system for providing automatically configurable secure file transfer protocol for a client, the system comprising:
first means for creating a property file, wherein the property file contains configuration information for the client;
second means for configuring software component parameters for sending and receiving files via a file transfer protocol and for encrypting the files prior to sending the files and decrypting the files after receiving the files, wherein the software component parameters are determined by the configuration information;
third means for monitoring the property file;
fourth means for reconfiguring software components for a client if the property file changes.

16. The system as recited in claim 15, wherein the property file is one of a plurality of property files wherein each property file corresponds to a different client and each of the plurality of property files is isolated from the other ones of the plurality of property files.

17. The system as recited in claim 15, wherein the configuration information comprises at least one of destination host, port, user identification, password, pickup directory, destination directory, and encryption public key file.

18. The system as recited in claim 15, further comprising:
fifth means for receiving a encrypted file via file transfer protocol;
sixth means for determining the identity of a client for which the file is intended;
seventh means for decrypting the encrypted file to create a decrypted file using a decryption algorithm determined by the property file associated with the client for which the file is intended.

19. The system as recited in claim 18, further comprising:
eighth means for, prior to decrypting the encrypted file, decompressing the encrypted file.

20. The system as recited in claim 15, further comprising:
fifth means for encrypting a file to be sent to a recipient using an encryption algorithm determined by the property file associated with the client for which the file is associated to produce an encrypted file;
sixth means for sending the encrypted file to a recipient using file transfer protocol.

21. The system as recited in claim 20, further comprising:
seventh means for, prior to encrypting the file, compressing the file.
